(19) United States
(12) Patent Application Publication
(10) Pub. No.: US 2007/0173362 A1
(43) Pub. Date: Jul. 26, 2007

(54) Chain or synchronous belt drive and tensioning or guiding element for integrating into a chain or synchronous belt drive

(76) Inventor: Thomas Ullein, Frensdorf (DE)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/590,553

(22) PCT Filed: Jan. 25, 2005
(86) PCT No.: PCT/EP05/00674

§ 371 Date: Aug. 24, 2006

(30) Foreign Application Priority Data
Feb. 26, 2004 (DE) 10 2004 009 170.6

(51) Int. Cl. F16H 7/18; F16H 7/08

(52) U.S. Cl. 474/140; 474/101; 474/111

(57) ABSTRACT

A chain or synchronous belt drive having at least one chain or synchronous belt wheel (3) is provided which is integrated into the drive, whereon the chain or synchronous belt (2) is guided. The chain or synchronous belt includes an over-jump protection element which overlaps, at least partially, the chain or synchronous belt (2) on an side opposite the wheel (3). The over-jump protection element (13) is arranged on a guiding or tensioning element (12).

### BACKGROUND

The invention relates to a chain or synchronous belt drive comprising at least one chain or synchronous belt wheel, which is integrated into the drive and by means of which the chain or synchronous belt is guided and engaged. Said chain or synchronous belt also comprises an over-jump protection element, which overlaps, at least partially, the chain or the synchronous belt on the side opposite the wheel.

Such chain or synchronous belt drives are used, for example, for driving shafts, such as, e.g., the camshaft or a compensating shaft or an oil pump of an internal combustion engine. At least one wheel, by means of which the traction mechanism is guided, is integrated into the traction mechanism drive, wherein usually several chain or belt wheels, around which the traction mechanism is wound, are provided. In order to guarantee that the traction mechanism is always under sufficient tension in order to drive the element or elements coupled with the one or several wheels, usually at least one tensioning element is provided, which, primarily for chain drives, but also for synchronous belt drives, is frequently a hydraulic damper, whose spring and restoring property can be generated by establishing a hydraulic pressure in the adjustment part. The hydraulic pressure is generated during operation, for example, by means of the motor oil of the internal combustion engine. Now the case can appear, for example, when the motor is stopped, that the oil escapes, consequently the tensioning element lies on a stop due to insufficient hydraulic function and thus cannot exert a damping force on the traction mechanism, which is driven nonetheless, at the moment of starting. This damping is achieved only when a sufficient hydraulic damping pressure has been reestablished. However, in the intermediate time, it is not guaranteed that the traction mechanism, that is, the chain or the synchronous belt, is tensioned sufficiently, which can lead to an undesired jumping of the chain or the belt over the chain or belt wheel. To prevent this situation, an over-jump protection element is provided, which is arranged in the region of the chain or belt wheel and which at least partially overlaps this wheel on the outside closely adjacent to the chain or to the belt. In this way, it is prevented that the chain or the belt can wander and jump over the chain or the belt wheel too far outwards in the radial direction; and it is held back by the over-jump protection element. Such an over-jump protection element is provided on a guide element integrated in the traction mechanism in known drives.

Now, however, the case can appear that it is not possible to use such an over-jump protection element. This can occur, for example, when installation space restrictions do not permit the over-jump protection element from being positioned in the relevant region. Another case is when the element adjacent to the wheel is a tensioning rail, which does not assume a fixed position; it is movable for tensioning purposes. Finally, to name another case, if the adjacent guide element lies in the chain drive, it is not possible to allow this element to be overlapped under corresponding lengthening on the outer side.

### SUMMARY

The invention is based on the objective of providing a chain or synchronous belt drive, which nevertheless offers the ability to prevent over-jumping even in cases, in which it is not possible to provide an over-jump protection element in the chain or synchronous belt drive of interest due to structural conditions.

To meet this objective, for a chain or synchronous belt drive of the type named above, it is provided according to the invention that the over-jump protection element is provided on an element guiding or tensioning an adjacent chain or an adjacent synchronous belt.

The invention advantageously uses the circumstance that frequently another drive lies adjacent to the chain or synchronous belt drive of interest, in which it is not possible to provide an over-jump protection element in drive-specific elements due to some reason and especially also even due to the reasons named above. The over-jump protection element is positioned virtually external to the drive, for which a guiding or tensioning element of the adjacent chain or synchronous belt drive is used. Primarily in traction mechanism drives in internal combustion engines, parallel drives are frequently provided, which are also coupled to each other kinematically from time to time, so that it is possible to give a guiding or tensioning element integrated in an adjacent traction mechanism drive a double function to the extent that it is simultaneously used for over-jump protection in the traction mechanism drive to be protected.

The adjacent traction mechanism drive can be any traction mechanism drive that is decoupled from the traction mechanism drive of interest. Equally, however, it is also conceivable that both traction mechanism drives are coupled kinematically, such that the adjacent chain or the adjacent synchronous belt is also guided by a common chain or synchronous belt wheel or a chain or synchronous belt wheel coupled to this common wheel.

According to a first configuration of the invention, the over-jump protection element itself can be connected integrally with the guiding or tensioning element of the adjacent traction mechanism drive. This element can be produced from plastic or metal, especially aluminum.

Alternatively, it is conceivable that the over-jump protection element is a component that is separate from the element and that is mounted on the element. This configuration is useful primarily when it is necessary, due to structural conditions, to mount the over-jump protection element only after installing the guiding or tensioning element in the traction mechanism drive. The over-jump protection element can be screwed tight, for example. Also, for this two-part embodiment, both parts can be composed of plastic or metal; naturally, it is also conceivable that, for example, the element is made from metal, e.g., aluminum, while the over-jump protection element, which is, for example, screwed onto the element, is made from plastic, or vice versa. For both one-piece and also multi-piece embodiments, the final material selection depends on the purpose of the application and the conditions prevailing during operation, especially the effective forces.

For secure guiding, it is useful when the over-jump protection element is embodied in the form of at least one plate, which is shaped preferably according to the outer contours of the chain or the synchronous belt to be overlapped and which projects laterally from the element, or in the form of a correspondingly shaped projection, wherein other shapes, which are not adapted to the outer contours, are also conceivable. This plate or this projection extend laterally away from the guiding or tensioning element, that is, they project out of the plane of the adjacent traction mechanism drive and project into the plane of the relevant traction mechanism drive, where the over-jump protection element is to exert its function. The side of the plate or of the projection facing the chain or the belt is configured according to the contours, so that the largest possible area overlap is produced. Naturally, it is also conceivable to embody the over-jump protection element in multiple parts with corresponding sections, which overlap the chain or the belt over a corresponding angle. Especially in the case of a plate it is useful when this is supported up to the protection element by a support element. This offers sufficient stability should the chain or the belt impact the over-jump protection element, if it moves somewhat out of its engaged position. Such a support element can be embodied, for example, as a crossbar or the like.

In an actual configuration of the invention, the element, which exerts the double function, namely the actual function in its traction mechanism drive and also the over-jump protection function in the adjacent traction mechanism drive, is a chain or synchronous belt tensioner integrated in the drive of an oil pump. Naturally, as alternatives, any other type of adjacent traction mechanism drive can be involved, e.g., a second control drive (if the first drive involves a control drive) or a compensating shaft drive or the like.

In addition to the chain or synchronous belt drive itself, the invention further relates to a tensioning or guiding element for integration into a chain or synchronous belt drive for tensioning or guiding the chain or the synchronous belt, with at least one over-jump protection element projecting laterally from the tensioning or guiding plate of the element for a chain or synchronous belt guided adjacent to the chain or to the synchronous belt. Other advantageous configurations of the tensioning or guiding element according to the invention emerge from the subordinate claims.

### BRIEF DESCRIPTION OF THE DRAWINGS

FIG. 1 shows, in the form of a basic view, two adjacent traction mechanism drives, wherein a tensioning or guiding element according to the invention is integrated into one traction mechanism drive,

FIG. 2 shows a perspective view of a section of the traction mechanism drive of FIG. 1,

FIG. 3 shows the section from FIG. 2 in a different perspective view, and

FIG. 4 shows a perspective view of a tensioning or guiding element according to the invention.

### DETAILED DESCRIPTION OF THE PREFERRED EMBODIMENTS

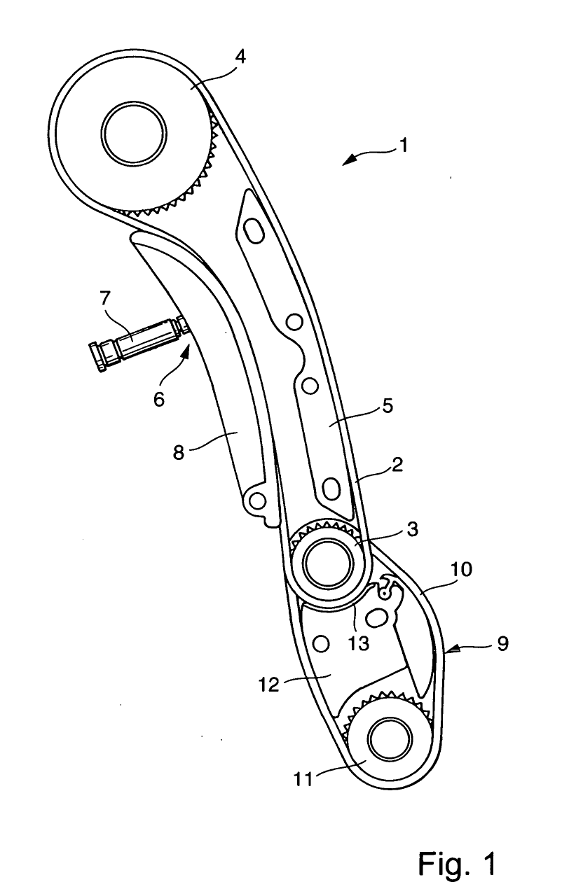

FIG. 1 shows a traction mechanism drive 1 according to the invention, comprising the traction mechanism in the form of a chain 2, which is guided around a driving chain wheel 3 and also a second chain wheel 4. This chain wheel 4 is coupled to an intake camshaft, which is not shown in more detail. The camshaft is controlled by the chain drive 1. To guide the chain 2 there is a guide rail 5 in the interior of the traction mechanism drive. To tension the chain 2 there is a tensioning element 6 comprising an element 7, e.g., a hydraulic damper, which generates the restoring force necessary for tensioning and on which a tensioning rail 8 is arranged. The hydraulic damper 7 presses the tensioning rail 8 against the chain 2, which is tensioned in this way.

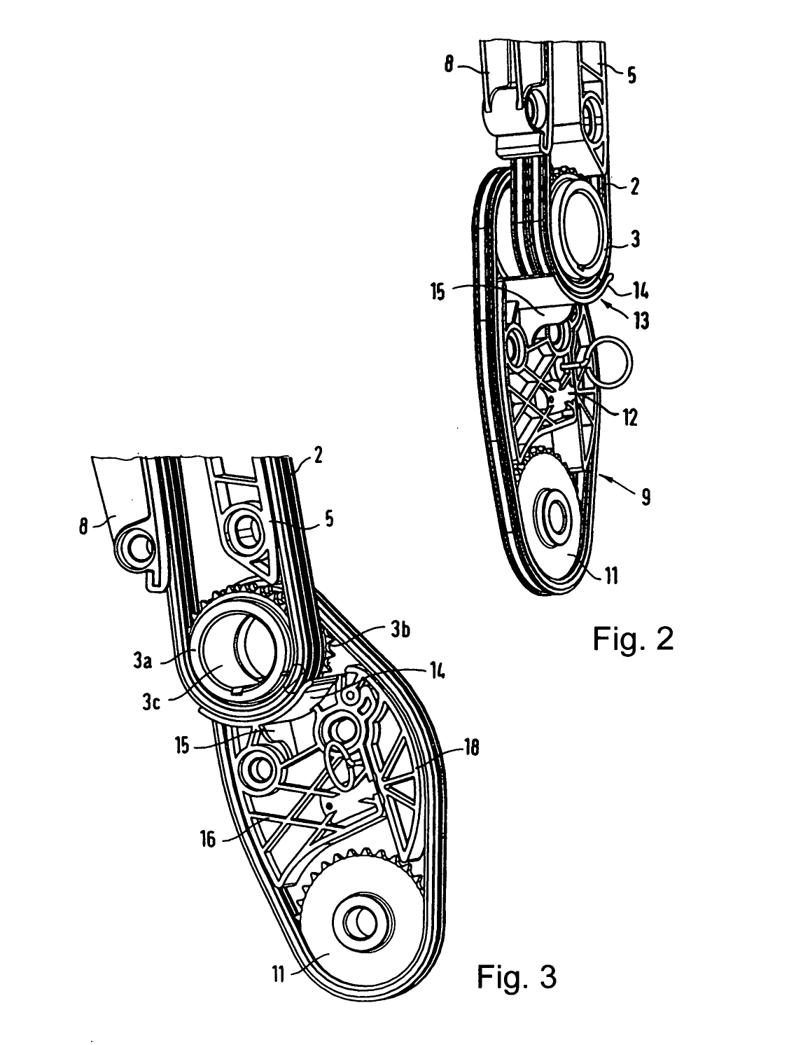

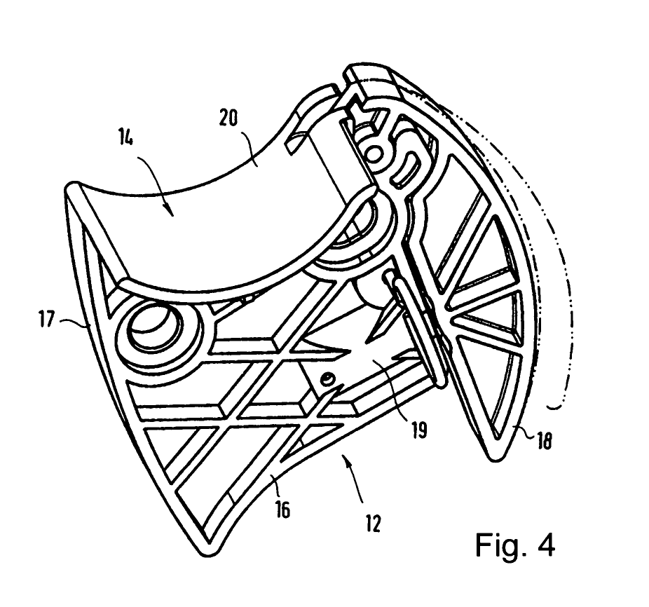

Further shown is a second traction mechanism drive 9, which is adjacent to the first traction mechanism drive, whose planes are thus parallel to each other. This drive also has a chain 10, which is guided by a chain wheel 11, by means of which, for example, an oil pump is driven. The chain 10 is further guided by the chain wheel 3, so that both traction mechanism drives 1, 9 are coupled to each other kinematically. As is visible from FIGS. 2 and 3, the chain wheel 3 involves a two-part chain wheel comprising the chain wheel part 3a and the chain wheel 3b, which are locked in rotation with each other by an inner sleeve 3c. To tension the chain 10, there is, in the interior of the chain drive 9, a tensioning element 12, which is discussed in more detail below with reference to FIG. 4.

To prevent the chain 2 from moving out of its loop around the chain wheel 3 and jumping over this wheel, on the tensioning element 12 there is an over-jump protection element 13 in the form of a flat projection or a plate 14 extending laterally outwards. This projection or the plate 14 extends laterally, see FIGS. 2, 3, and 4, out of the plane of the traction mechanism drive 9 and is positioned in the installed position, as shown in the figures, so that it at least partially overlaps the chain 2 in the region, in which it wraps around the chain wheel 3. Here, the extending projection or the plate 14 is shaped, so that the side facing the chain 2 corresponds essentially to the chain shape in the overlapping region. By means of a support element 15, the projection or the plate 14 is supported up to the tensioning element 12. Due to the small distance that the projection or the plate 14, which is stationary in the installed position, assumes relative to the chain 2, over-jumping is effectively prevented.

FIG. 4 shows the tensioning element 12 known from FIGS. 1-3 in an enlarged detail view. The tensioning element 12 has a honeycomb or chamber-like structure comprising a fixed part 16, on which a guide surface 17 for the chain 10 is provided, and also a moving, spring-like part 18, which can move as shown by the dash-dot line in FIG. 4 via a spring, which is arranged in the chamber 19 and which is not shown in more detail.

Clearly visible is the projection or the plate 14, which projects laterally, and its surface 20 directed towards the chain 2 in the installed position is clearly arc-shaped. The tensioning element 12 itself is preferably a one-piece component, that is, the projection or the plate 14 is integrated at least with the stationary part 16 (if necessary, the spring-like part can be a separate part, which is pivotally attached to the fixed part 16). The tensioning element can be made from metal or plastic. However, it is also conceivable that it involves a two-piece embodiment, in which the projection or the plate 14 is mounted on the stationary part of the tensioning element by separate attachment means, e.g., screws. In this case, both can also be made from the same material. It is also conceivable that one part is made from plastic and the other is made from metal.

The integration of the over-jump projection element into an adjacent traction mechanism drive through the arrangement of the over-jump protection element on an adjacent tensioning or guiding element permits, in a simple way, the arrangement of guide protection also in regions, where this is not possible due to structural circumstances. The over-jump protection element, especially in the case of an embodiment in the form of a relatively thin-walled plate, can also be integrated into a very narrow installation space. Due to the arrangement on an already existing tensioning or guiding element, no installation expense is also necessary. Incidentally, a cost-effective production of the tensioning or guiding element according to the invention with the over-jump protection element is also possible due to the simplicity of the embodiment.

### LIST OF REFERENCE SYMBOLS

1 Traction mechanism drive
2 Chain
3 Chain wheel
4 Chain wheel
5 Guide rail
6 Tensioning element
7 Hydraulic damper
8 Tensioning rail
9 Traction mechanism drive
10 Chain
11 Chain wheel
12 Tensioning element
13 Over-jump protection element
14 Projection or plate
15 Support element
16 Fixed part
17 Guide surface
18 Moving, spring-like part
19 Chamber
20 Surface

1. Chain or synchronous belt drive comprising at least one chain or synchronous belt wheel, which is integrated in the drive and through which the chain or the synchronous belt is guided and engaged, as well as with an over-jump protection element, which at least partially overlaps the chain or the synchronous belt on a side opposite the wheel, the over-jump protection element is provided on an element guiding or tensioning an adjacent chain or an adjacent synchronous belt.

2. Chain or synchronous belt drive according to claim 1, wherein the adjacent chain or the adjacent synchronous belt is also guided by a common chain or synchronous belt wheel or a chain or synchronous belt wheel coupled with the common wheel.

3. Chain or synchronous belt drive according to claim 1, wherein the over-jump protection element is connected integrally to the element.

4. Chain or synchronous belt drive according to claim 3, wherein the element is made from plastic or metal.

5. Chain or synchronous belt drive according to claim 1, wherein the over-jump protection element is a component that is separate from the element and is mounted on the element.

6. Chain or synchronous belt drive according to claim 5, wherein the over-jump protection element and the element are composed of plastic or metal or of different materials.

7. Chain or synchronous belt drive according to claim 1, wherein the over-jump protection element comprises at least one plate or projection, which is shaped according to outer contours of the chain or synchronous belt to be overlapped and which projects laterally from the element.

8. Chain or synchronous belt drive according to claim 7, wherein the plate or the projection is supported by a support element that extends to the element.

9. Chain or synchronous belt drive according to claim 1, wherein the element is a chain or synchronous belt tensioner integrated in a drive of an oil pump.

10. Tensioning or guiding element for integration in a traction mechanism drive for tensioning or guiding the traction mechanism, comprising at least one laterally projecting over-jump protection element for a chain or synchronous belt guided adjacent to the chain or to the synchronous belt.

11. Tensioning or guiding element according to claim 10, wherein the tensioning or guiding element is a one-piece part.

12. Tensioning or guiding element according to claim 11, wherein the tensioning or guiding element is made from plastic or metal.

13. Tensioning or guiding element according to claim 10, wherein the over-jump protection element is a component that is separate from the element and is mounted on the element.

14. Tensioning or guiding element according to claim 13, wherein the over-jump protection element and the element are comprised of plastic or metal or of different materials.

15. Tensioning or guiding element according to claim 10, wherein the over-jump protection element comprises at least one plate or projection, which is shaped according to outer contours of the chain or synchronous belt to be overlapped and which projects laterally.

16. Tensioning or guiding element according to claim 15, wherein the plate or the projection is supported by a support element that extends to the element.
